(19) United States
(12) Patent Application Publication
(10) Pub. No.: US 2006/0168066 A1
(43) Pub. Date: Jul. 27, 2006

(54) Email anti-phishing inspector

(76) Inventors: David Helsper, Marietta, GA (US); Jeffrey Burdette, Norcross, GA (US); Robert B. Friedman, Decatur, GA (US)

Correspondence Address: NEEDLE & ROSENBERG, P.C., SUITE 1000, 999 PEACHTREE STREET, ATLANTA, GA, 30309-3915, US

(21) Appl. No.: 11/298,370

(22) Filed: Dec. 9, 2005

Related U.S. Application Data
(63) Continuation-in-part of application No. 10/985,664, filed on Nov. 10, 2004.

(51) Int. Cl. G06F 15/16

(52) U.S. Cl. 709/206

(57) ABSTRACT

A method, system, and computer program product are provided for implementing embodiments of an EScam Server, which are useful for determining phishing emails. Methods, systems, and program products are also provided to implement embodiments of a Trusted Host Miner, useful for determining servers associated with a Trusted URL, a Trusted Host Browser, useful for communicating to a user when links are Trusted URLs, and a Page Spider, useful for determining on-site links to documents which request a user's confidential information.

### CROSS-REFERENCE TO RELATED PATENT APPLICATIONS

This application is a continuation-in-part of U.S. Utility patent application Ser. No. 10/985,664, filed Nov. 10, 2004 which is incorporated herein in its entirety by reference.

### BACKGROUND OF THE INVENTION

1. Field of the Invention

The present invention relates to techniques for detecting email messages used for defrauding an individual (such as so-called “phishing” emails). The present invention provides a method, system and computer program product (hereinafter “method” or “methods”) for accepting an email message and determining whether the email message is a phishing email message. The present invention also includes methods for evaluating a requested URL to determine if the destination URL is a “trusted” host and is geographically located where expected, as well as methods for communicating the determined level of trust to a user. The present invention further includes methods for mining Trusted Hosts, which associates one or more Internet Protocol (IP) addresses of a Trusted Server with a Trusted URL. Methods are also provided for processing links in documents to determine on-site links to documents which request confidential information from a user.

2. Description of the Related Art

Phishing is a scam where a perpetrator sends out legitimate looking emails appearing to come from some of the World Wide Web's biggest and most reliable web sites for example—eBay, PayPal, MSN, Yahoo, CitiBank, and America Online—in an effort to “phish” for personal and financial information from an email recipient. Once the perpetrator obtains such information from the unsuspecting email recipient, the perpetrator subsequently uses the information for personal gain.

There are a large number of vendors today providing anti-phishing solutions. These solutions do not help to manage phishing emails proactively. Instead, they rely on providing early warnings based on known phishing emails, black lists, stolen brands, etc.

Currently, anti-phishing solutions fall into three major categories:
1) Link Checking Systems use black lists or behavioral technologies that are browser based to determine whether a site is linked to a spoofed site. Unfortunately, systems using black list solutions are purely reactive solutions that rely on third party updates of IP addresses that are hosting spoofed sites.
2) Early Warning Systems use surveillance of phishing emails via “honey pots” (a computer system on the Internet that is expressly set up to attract and ‘trap’ people who attempt to penetrate other people's computer systems), online brand management and scanning, Web server log analysis, and traffic capture and analysis technologies to identify phishing emails. These systems will identify phishing attacks quickly so that member institutions can get early warnings. However, none of these systems is proactive in nature. Therefore, these systems fail to protect a user from being victimized by a spoofed site.
3) Authentication and Certification Systems use trusted images embedded in emails, digital signatures, validation of an email origin, etc. This allows the customer to determine whether or not an email is legitimate

Current anti-phishing solutions fail to address phishing attacks in real time. Businesses using a link checking system must rely on a black list being constantly updated for protection against phishing attacks. Unfortunately, because the link checking system is not a proactive solution and must rely on a black list update, there is a likelihood that several customers will be phished for personal and financial information before an IP address associated with the phishing attack is added to the black list. Early warning systems attempt to trap prospective criminals and shut down phishing attacks before they happen; however, they often fail to accomplish these goals because their techniques fail to address phishing attacks that do not utilize scanning. Authentication and certification systems are required to use a variety of identification techniques; for example, shared images between a customer and a service provider which are secret between the two, digital signatures, and code specific to a particular customer being stored on the customer's computer. Such techniques are intrusive in that software must be maintained on the customer's computer and periodically updated by the customer.

Accordingly, there is a need and desire for an anti-phishing solution that proactively stops phishing attacks at a point of attack and that is minimally intrusive.

There is also a need for a solution that can proactively verify that a destination host is trusted without the use of black lists or white lists.

A method is also needed to determine a phishing email based on at least the level of trust associated with a URL extracted from the email.

A further need exists to associate one or more IP addresses of a Trusted Server with a Trusted URL, and a need to communicate to a user the level of trust associated with the host of a URL.

Finally, a method for processing links in documents to determine on-site links to documents which request confidential information is also needed in the art.

### SUMMARY OF THE INVENTION

The present invention provides methods for determining whether an email message is being used in a phishing attack in real time. In one embodiment, before an end user receives an email message, the email message is analyzed by a server to determine if the email message is a phishing email. The server parses the email message to obtain information which is used in an algorithm to create a phishing score. If the phishing score exceeds a predetermined threshold, the email is determined to be a phishing email message. In a further embodiment, an email can be determined a phishing email based on a comparison between descriptive content extracted from the email and stored descriptive content.

Methods are also provided in the present invention for associating one or more IP addresses of a Trusted Server with a Trusted URL. Further methods are provided for processing links in a document to determine on-site links which reference documents requesting confidential information.

The present invention also provides methods for determining if a requested URL destination is a Trusted Host. In one embodiment, when a user chooses to visit a URL with a browser, the content of the destination page is scanned for indications that the page contains information that should only come from a Trusted Host. If the page contains information that should only be returned from a Trusted Host, the destination host is then checked to verify that the host is a Trusted Host contained in a Trusted Host database (DB). If it is not, the user is alerted that the content should not be trusted.

### BRIEF DESCRIPTION OF THE DRAWINGS

The foregoing and other advantages and features of the invention will become more apparent from the detailed description of the embodiments of the invention given below with reference to the accompanying drawings.

FIG. 1 is a flow chart illustrating a method for determining whether an email message is a phishing email in accordance with the present invention.

FIG. 2 is a block diagram of a computer system for implementing one embodiment of the EScam Server of the present invention.

FIG. 3 is a block diagram of a computer system which may be used for implementing various embodiments of the present invention.

FIG. 4 illustrates a method for determining a phishing email in one embodiment of the present invention.

FIG. 5 illustrates a method for determining a phishing email in another embodiment of the present invention.

FIG. 6 illustrates a method for determining a phishing email in a further embodiment of the present invention.

FIG. 7 illustrates the Trusted Host Miner method of one embodiment of the present invention.

FIG. 8 illustrates the Trusted Host Miner method of another embodiment of the present invention.

FIG. 9 illustrates the Trusted Host Browser method of one embodiment of the present invention.

FIG. 10 illustrates the Trusted Host Browser method in another embodiment of the present invention.

FIG. 11 illustrates the Page Spider method of one embodiment of the present invention.

FIG. 12 illustrates the Page Spider and Trusted Host Miner methods operative in one embodiment of the present invention.

In the following detailed description, reference is made to the accompanying drawings, which form a part hereof, and in which is shown by way of illustration of specific embodiments in which the invention may be practiced. These embodiments are described in sufficient detail to enable those skilled in the art to practice the invention, and it is to be understood that other embodiments may be utilized, and that structural, logical and programming changes may be made without departing from the spirit and scope of the present invention.

### DETAILED DESCRIPTION OF THE INVENTION

Before the present methods, systems, and computer program products are disclosed and described, it is to be understood that this invention is not limited to specific methods, specific components, or to particular compositions, as such may, of course, vary. It is also to be understood that the terminology used herein is for the purpose of describing particular embodiments only and is not intended to be limiting.

Unless otherwise expressly stated, it is in no way intended that any method or embodiment set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification. Furthermore, while various embodiments provided in the current application refer to the statutory classes of methods, systems, or computer program products, it should be noted that the present invention may be carried out, embodied, or claimed in any statutory class.

The term “EScam Score” refers to a combination of values that include a Header Score and a Uniform Resource Locator (URL) Score. The EScam Score represents how suspicious a particular email message may be.

The term “Header Score” refers to a combination of values associated with an internet protocol (IP) address found in an email message being analyzed.

The term “URL Score” refers to a combination of values associated with a URL found in an email message being analyzed.

The term “Non-Trusted Country” refers to a country that is designated by an EScam Server as a country not to be trusted, but is not a high-risk country or an Office of Foreign Assets Control (OFAC) country (defined below).

The term “High Risk Country” refers to a country that is designated by the EScam Server as a country that has higher than normal crime activity, but is not an OFAC country.

The term “Trusted Country” refers to a country that is designated by the EScam Server as a country to be trusted.

The term “OFAC Country” refers to a country having sanctions imposed upon it by the United States or another country.

The term “EScam Message” refers to a text field provided by the EScam Server describing the results of the EScam Server's analysis of an email message.

The term “EScam Data” refers to a portion of an EScam Server report detailing all IP addresses in the email Header and all URLs within the body of the email message.

The operation of a NetAcuity Server 240 which may be used in the present invention is discussed in U.S. Pat. No. 6,855,551, which is commonly assigned to the assignee of the present application, and which is herein incorporated by reference in its entirety.

EScam Server

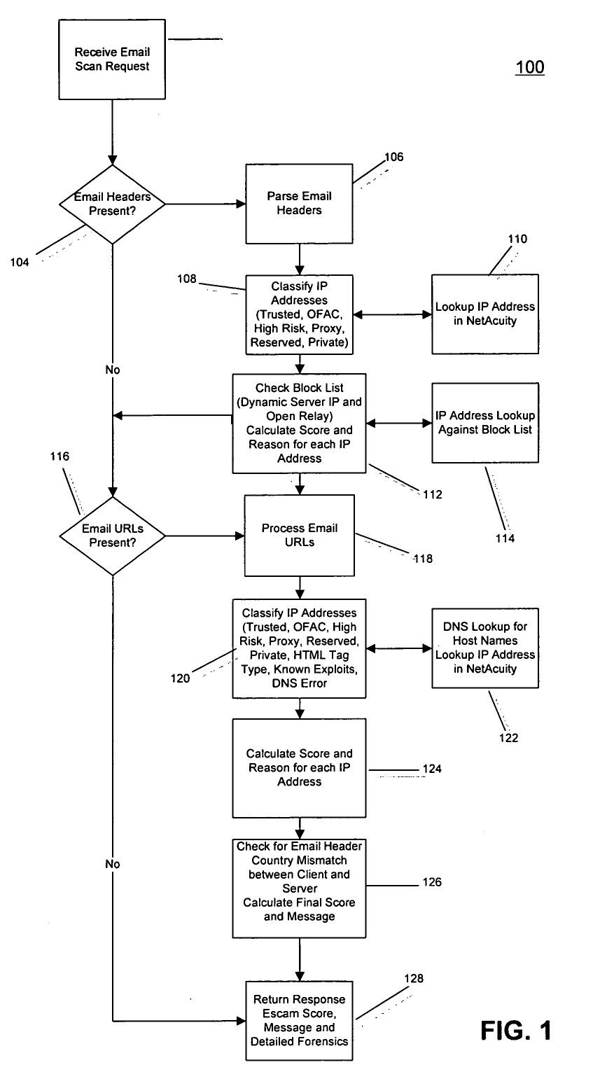

FIG. 1 is a flow chart illustrating steps for determining whether an email message is a phishing email in one embodiment of the present invention. At step 102, when EScam Server 202 receives a request to scan an email message, the EScam Server 202 initiates processing of the email message. Next at step 104, the EScam Server 202 determines if any email headers are present in the email message. If email headers are not present in the email message, the EScam Server 202 proceeds to step 116. If email headers are present in the email message, at step 106, the EScam Server 202 parses the email headers from the email message to obtain IP addresses from the header. Next at step 108, the EScam Server 202 determines how the IP addresses associated with the header should be classified for subsequent scoring. For example, classifications and scoring for the IP addresses associated with the header could be the following:

| Header Attribute | Score |
|---|---|
| Reserved Address | 5 |
| High Risk Country | 4 |
| OFAC Country | 4 |
| Non-Trusted Country | 3 |
| Anonymous proxy (email header only) | 4 |
| Open Relay | 4 |
| For multiple countries found in the header | 1 (Each unique country adds a |
| | point) |
| Dynamic Server IP address | 1 |

Once the IP address has been classified at step 108, the EScam Server 202 transfers the IP address to a NetAcuity Server 240 to determine a geographic location of the IP address associated with the email header, at step 110. The NetAcuity Server 240 may also determine if the IP address is associated with an anonymous proxy server. Next at step 112, the IP address is checked against a block list to determine if the IP address is an open relay server or a dynamic server. The determination in step 112 occurs by transferring the IP address to, for example, a third party for comparisons with a stored block list (step 114). In addition, at step 112, the EScam Server 202 calculates a Header Score.

Subsequent to step 114, all obtained information is sent to EScam Server 202. Next, at step 116, EScam Server 202 determines if any URLs are present in the email message. If no URLs are present in the email message, the EScam Server 202 proceeds to step 128. If a URL is present, the EScam Server 202 processes the URL at step 118 using an EScam API 250 to extract host names from the body of the email message. Next at step 120, the EScam Server 202 determines how the IP address associated with the URL should be classified for subsequent scoring by examining Hypertext Markup Language (HTML) tag information associated with the IP address. For example, classifications and scoring for the IP address associated with the URL could be the following:

| URL Attribute | Score |
|---|---|
| Map | 5 |
| Form | 5 |
| Link | 4 |
| Image | 2 |

Once the IP address has been classified, at step 120, the EScam Server 202 transfers the IP address to the NetAcuity Server 240 to determine a geographic location of the IP address associated with the URL (step 122). Next, at step 124, the EScam Server 202 calculates a score for each IP address associated with the email message and generates a combined URL score and a reason code for each IP address. The reason code relates to a reason why a particular IP address received its score. For example, the EScam Server 202 may return a reason code indicating that an email is determined to be suspect because the IP address of the email message originated from an OFAC country and the body of the email message contains a link that has a hard coded IP address.

At step 126, EScam Server 202 compares a country code from an email server associated with the email message header and a country code from an email client to ensure that the two codes match. The EScam Server 202 obtains country code information concerning the email server and email client using the NetAcuity Server 240, which determines the location of the email server and client server and returns a code associated with a particular country for the email server and email client. If there is a mismatch between the country code of the email server and the country code of the email client, the email message is flagged and the calculated scored is adjusted accordingly. For example, upon a mismatch between country codes, the calculated score may be increased by 1 point.

In addition, an EScam Score is calculated. The EScam Score is a combination of the Header Score and URL Score. The EScam Score is determined by adding the score for each IP address in the email message and aggregating them based on whether the IP address was from the email header or a URL in the body of the email. The calculation provides a greater level of granularity when determining whether an email is fraudulent.

The EScam Score may be compared with a predetermined threshold level to determine if the email message is a phishing email. For example, if the final EScam Score exceeds the threshold level, the email message is determined to be a phishing email. In one embodiment, determinations by the EScam Server 202 may only use the URL score to calculate the EScam Score. If, however, the URL score is over a certain threshold, the Header Score can also be factored into the EScam Score calculation.

Lastly, at step 128, the EScam Server 202 outputs an EScam Score, an EScam Message and EScam Data to an email recipient including detailed forensic information concerning each IP address associated with the email message. The detailed forensic information may be used to track down the origin of the suspicious email message and allow law enforcement to take action. For example, forensic information gleaned by the EScam server 202 during an analysis of an email message could be the following:

X-eScam-Score: 8
X-eScam-Message: Non-Trusted Country/Hardcoded URL in MAP tag
X-eScam-Data: --- Begin Header Report ---
X-eScam-Data: 1: 192.168.1.14 PRIV DHELSPERLAPTOP
X-eScam-Data: 1: Country: *** Region: *** City: private
X-eScam-Data: 1: Connection Speed: ?
X-eScam-Data: 1: Flags: PRIVATE
X-eScam-Data: 1: Score: 0 [Scanned Clean]
X-eScam-Data: --- End Header Report ---
X-eScam-Data: --- Begin URL Report ---
X-eScam-Data: 1: <A> [167.88.194.136] www.wamu.com
X-eScam-Data: 1: Country: usa Region: wa City: seattle
X-eScam-Data: 1: Connection Speed: broadband
X-eScam-Data: 1: Flags:
X-eScam-Data: 1: Score: 0 [URL Clean]
X-eScam-Data: 2: <AREA> [62.141.56.24] 62.141.56.24
X-eScam-Data: 2: Country: deu Region: th City: erfurt
X-eScam-Data: 2: Connection Speed: broadband
X-eScam-Data: 2: Flags: NON-TRUST
X-eScam-Data: 2: Score: 8 [Non-Trusted Country/Hardcoded URL in
MAP tag]
X-eScam-Data: --- End URL Report ---
X-eScam-Data: --- Begin Process Report ---
X-eScam-Data: -: Header Score: 0 URL Score: 8
X-eScam-Data: -: Processed in 0.197 sec
X-eScam-Data: --- End Process Report ---

Depending on a system configuration, email messages that have been determined to be phishing emails may also be for example, deleted, quarantined, or simply flagged for review.

EScam Server 202 may utilize domain name server (DNS) lookups to resolve host names in URLs to IP addresses. In addition, when parsing the headers of an email message at step 106, the EScam Server 202 may identify the IP address that represents a final email server (email message origination server) in a chain, and the IP address of the sending email client of the email message, if available. The EScam Server 202 uses the NetAcuity Server 240 (step 110) for the IP address identification. The EScam Server 202 may also identify a sending email client.

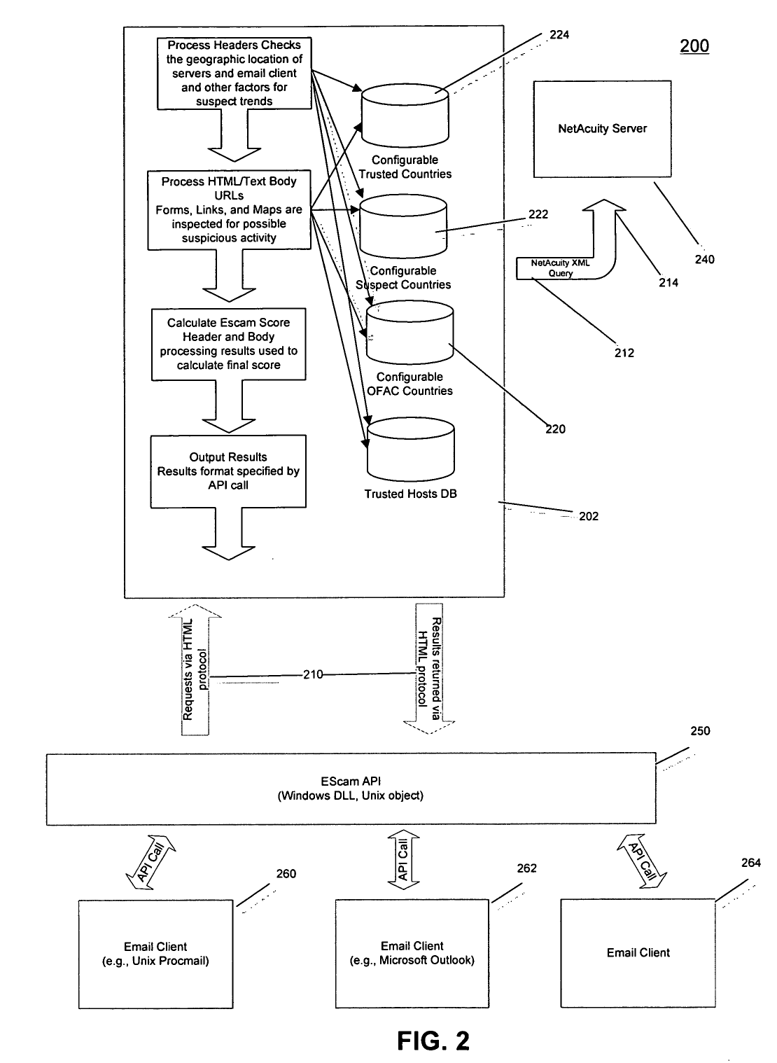

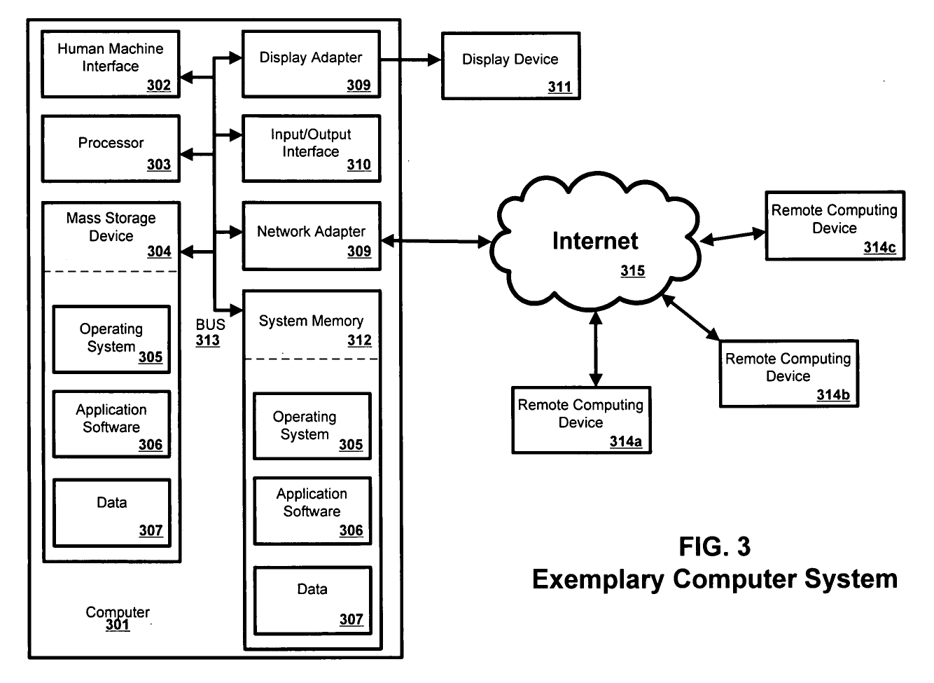

FIG. 2 is an exemplary processing system 200 with which the present invention may be used. System 200 includes a NetAcuity Server 240, a Communications Interface 212, a NetAcuity API 214, an EScam Server 202, a Communications Interface 210, an EScam API 250 and at least one email client, for example email client 260. The EScam Server 202, NetAcuity Server 240, and Email Clients 260, 262, 264 may each be operative on one or more computer systems as embodied in FIG. 3, which is discussed in more detail below. Within the EScam Server 202 resides multiple databases (220, 222 and 224) which store information. For example, database 220 stores a list of OFAC country codes that may be compared with country codes associated with an email message. Database 222 stores a list of suspect country codes that may be compared with country codes associated with the email message. Database 224 stores a list of trusted country codes that may be compared with country codes associated with the email message.

The EScam API 250 provides an interface between the EScam Server 202 and third party applications, such as a Microsoft Outlook email client 262 via various function calls from the EScam Server 202 and third party applications. The EScam API 250 provides an authentication mechanism and a communications conduit between the EScam Server 202 and third party applications using, for example, a TCP/IP protocol. The EScam API 250 performs parsing of the email message body to extract any host names as well as any IP addresses residing within the body of the email message. The EScam API 250 also performs some parsing of the email header to remove information determined to be private, such as a sending or receiving email address.

The EScam API 250 may perform the following interface functions when an email client (260, 262 and 264) attempts to send an email message to EScam Server 202:
Parse an email message into headers and body.
Process the headers and remove To:, From: and Subject: information from the email message.
Process the body of the message and retrieve URLs in preparation for sending to the EScam server 202.
Send the prepared headers and URLs to the EScam Server 202.
Retrieve a return code from the EScam Server 202 once processing by the EScam Server 202 is complete.
Retrieve a textual message resulting from processing conducted by the EScam Server 202.
Retrieve a final EScam Score from the EScam Server 202 once processing of the email message is complete.
Retrieve a final EScam Message from the EScam Server 202 once processing of the email message is complete.
Retrieve an EScam Detail from the EScam Server 202 when processing of the email message is complete.
Retrieve the Header Score.
Retrieve the URL Score.

An additional support component may be included in system 200 which allows a particular email client, for example, email client 260, to send incoming email messages to the EScam Server 202 prior to being placed in an email recipient's Inbox (not shown). The component may use the EScam API 250 to communicate with the EScam Server 202 using the communications conduit. Based on the EScam Score returned by the EScam Server 202, the component may, for example, leave the email message in the email recipient's Inbox or move the email message into a quarantine folder. If the email message is moved into the quarantine folder, the email message may have the EScam Score and message appended to the subject of the email message and the EScam Data added to the email message as an attachment.

Accordingly, the present invention couples IP Intelligence with various attributes in an email message. For example, IP address attributes of the header and URLs in the body are used by the present invention to apply rules for calculating an EScam Score which may be used in determining whether the email message is being used in a phishing ploy. Each individual element is scored based on a number of criteria, such as an HTML tag or whether or not an embedded URL has a hard coded IP address. The present invention may be integrated into a desktop (not shown) or on a backend mail server.

In a backend mail server implementation for system 200, the EScam API 250 may be integrated into the email client, for example, email client 260. As the email client 260 receives an email message, the email client 260 will pass the email message to the EScam Server 202 for analysis via the EScam API 250 and a Communications Interface 210. Based on the return code, the EScam Server 202 determines whether to forward the email message to an email recipient's Inbox or perhaps discard it.

If a desktop integration is utilized, email clients and anti-virus vendors may use an EScam Server 202 having a Windows based EScam API 250. A desktop client may subsequently request the EScam Server 202 to analyze an incoming email message. Upon completion of the analysis by the EScam Server 202, an end user may determine how the email message should be treated based on the return code from the EScam Server 202; for example, updating the subject of the email message to indicate the analyzed email message is determined to be part of a phishing ploy. The email message may also be moved to a quarantine folder if the score is above a certain threshold.

The methods of the present invention can be carried out using a processor programmed to carry out the various embodiments. FIG. 3 is a block diagram illustrating an exemplary computer system for performing the disclosed methods. This exemplary computer system is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The method can be operational with numerous other general purpose or special purpose computing system environments or configurations. Examples of well known computing systems, environments, and/or configurations that may be suitable for use with the method include, but are not limited to, personal computers, server computers, laptop devices, and multiprocessor systems. Additional examples include set top boxes, programmable consumer electronics, network PCs, minicomputers, mainframe computers, distributed computing environments that include any of the above systems or devices, and the like.

The methods may be described in the general context of computer instructions, such as program modules, being executed by a computer. Generally, program modules include routines, programs, objects, components, data structures, etc. that perform particular tasks or implement particular abstract data types. The methods may also be practiced in distributed computing environments where tasks are performed by remote processing devices that are linked through a communications network. In a distributed computing environment, program modules may be located in both local and remote computer storage media including memory storage devices.

The methods disclosed herein can be implemented via a general-purpose computing device in the form of a computer 301. The components of the computer 301 can include, but are not limited to, one or more processors or processing units 303, a system memory 312, and a system bus 313 that couples various system components including the processor 303 to the system memory 312.

The processor 303 in FIG. 3 can be an x-86 compatible processor, including a PENTIUM IV, manufactured by Intel Corporation, or an ATHLON 64 processor, manufactured by Advanced Micro Devices Corporation. Processors utilizing other instruction sets may also be used, including those manufactured by Apple, IBM, or NEC.

The system bus 313 represents one or more of several possible types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus. This bus, and all buses specified in this description can also be implemented over a wired or wireless network connection. The bus 313, and all buses specified in this description can also be implemented over a wired or wireless network connection and each of the subsystems, including the processor 303, a mass storage device 304, an operating system 305, application software 306, data 307, a network adapter 308, system memory 312, an Input/Output Interface 310, a display adapter 309, a display device 311, and a human machine interface 302, can be contained within one or more remote computing devices 314a,b,c at physically separate locations, connected through buses of this form, in effect implementing a fully distributed system.

The operating system 305 in FIG. 3 includes operating systems such as MICROSOFT WINDOWS XP, WINDOWS 2000, WINDOWS NT, or WINDOWS 98, and REDHAT LINUX, FREE BSD, or SUN MICROSYSTEMS SOLARIS. Additionally, the application software 306 may include web browsing software, such as MICROSOFT INTERNET EXPLORER or MOZILLA FIREFOX, enabling a user to view HTML, SGML, XML, or any other suitably constructed document language on the display device 311.

The computer 301 typically includes a variety of computer readable media. Such media can be any available media that is accessible by the computer 301 and includes both volatile and non-volatile media, removable and non-removable media. The system memory 312 includes computer readable media in the form of volatile memory, such as random access memory (RAM), and/or non-volatile memory, such as read only memory (ROM). The system memory 312 typically contains data such as data 307 and and/or program modules such as operating system 305 and application software 306 that are immediately accessible to and/or are presently operated on by the processing unit 303.

The computer 301 may also include other removable/non-removable, volatile/non-volatile computer storage media. By way of example, FIG. 3 illustrates a mass storage device 304 which can provide non-volatile storage of computer code, computer readable instructions, data structures, program modules, and other data for the computer 301. For example, a mass storage device 304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules can be stored on the mass storage device 304, including by way of example, an operating system 305 and application software 306. Each of the operating system 305 and application software 306 (or some combination thereof) may include elements of the programming and the application software 306. Data 307 can also be stored on the mass storage device 304. Data 304 can be stored in any of one or more databases known in the art. Examples of such databases include, DB2®, Microsoft® Access, Microsoft® SQL Server, Oracle®, mySQL, PostgreSQL, and the like. The databases can be centralized or distributed across multiple systems.

A user can enter commands and information into the computer 301 via an input device (not shown). Examples of such input devices include, but are not limited to, a keyboard, pointing device (e.g., a “mouse”), a microphone, a joystick, a serial port, a scanner, touch screen mechanisms, and the like. These and other input devices can be connected to the processing unit 303 via a human machine interface 302 that is coupled to the system bus 313, but may be connected by other interface and bus structures, such as a parallel port, serial port, game port, or a universal serial bus (USB).

A display device 311 can also be connected to the system bus 313 via an interface, such as a display adapter 309. For example, a display device can be a cathode ray tube (CRT) monitor or an Liquid Crystal Display (LCD). In addition to the display device 311, other output peripheral devices can include components such as speakers (not shown) and a printer (not shown) which can be connected to the computer 301 via Input/Output Interface 310.

The computer 301 can operate in a networked environment using logical connections to one or more remote computing devices 314a,b,c. By way of example, a remote computing device can be a personal computer, portable computer, a server, a router, a network computer, a peer device or other common network node, and so on. Logical connections between the computer 301 and a remote computing device 314a,b,c can be made via a network such as a local area network (LAN), a general wide area network (WAN), or the Internet. Such network connections can be through a network adapter 308.

For purposes of illustration, application programs and other executable program components such as the operating system 305 are illustrated herein as discrete blocks, although it is recognized that such programs and components reside at various times in different storage components of the computing device 301, and are executed by the data processor(s) of the computer. An implementation of application software 306 may be stored on or transmitted across some form of computer readable media. An implementation of the disclosed methods may also be stored on or transmitted across some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Phishing Email Determiner

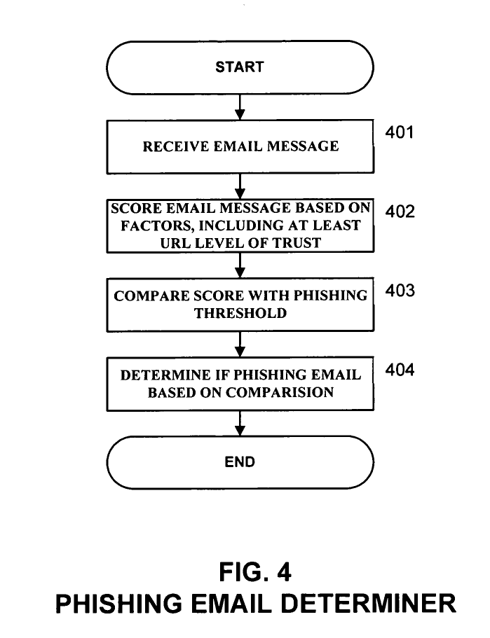

In one embodiment of the present invention, a Phishing Email Determiner (PED) is provided for determining a phishing email using one or more factors, with at least one factor being the level of trust associated with a URL extracted from the email. The embodiment of FIG. 4 illustrates one such method for determining a phishing email.

First, in the embodiment of FIG. 4, an email message is received 401. Second, the email message is scored based on one or more factors, with at least one factor based on the level of trust associated with a URL extracted from the email 402. Third, the score is compared with a predetermined phishing threshold 403. Finally, the email is determined to be a phishing email based on the comparison 404.

In an embodiment based on the embodiment of FIG. 4, the level of trust associated with the URL is determined as a function of an IP address associated with the URL. The IP address associated with the URL may be determined by querying a DNS server. In various embodiments, the determination that the email is a phishing email may occur in real time, near real time, or at predetermined time intervals.

A database of the kind which may be operative on the computer system of FIG. 3 can be used in various embodiments of the Phishing Email Determiner of FIG. 4. For example, one or more factors may be stored in a database, or the level of trust associated with the URL may be stored or retrieved from a database. In one embodiment, a factor may be the geographic location of origination of the email message, which may be determined as a function of the origination IP address of the email message. A NetAcuity Server 240 may be used in various embodiments to determine the geographic location of origination of the email message based on the IP origination address of the message.

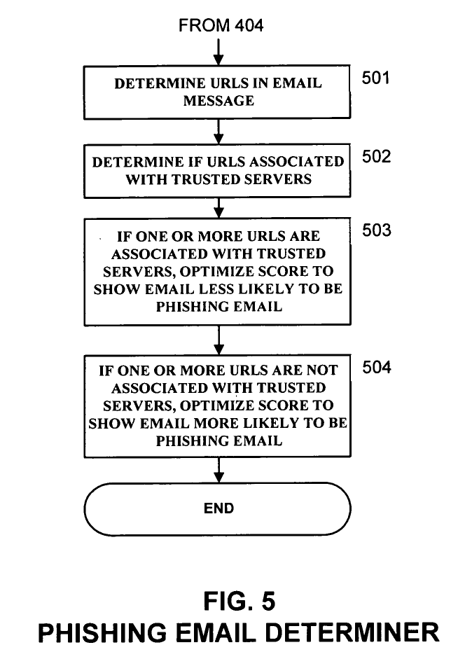

In a further embodiment of the Phishing Email Determiner extending the embodiment of FIG. 4 and illustrated in FIG. 5, one or more URLs within the email message may be analyzed to determine if they are associated with a Trusted Server in order to optimize the email's risk score. First, one or more URLs within the email message are determined 501. Second, it is determined if one or more of the URLs are associated with a Trusted Server 502. Third, if each of the one or more URLs are associated with a Trusted Server, the risk score is optimized to reflect that the email is less likely to be a phishing email 503. Accordingly, if fewer than all of the one or more URLs are not associated with Trusted Servers, the risk score is optimized to reflect that the email is more likely to be a phishing email 504.

In yet another embodiment of the PED based on the embodiment of FIG. 4, the email message is parsed into a header and a body. Such an email may contain data in one of many formats, including plain text, HTML, XML, rich text, and the like. Accordingly, after the email is parsed into a header and a body, the risk score is comprised of a Header Score and a URL Score, where the URL Score can be adjusted based on an HTML tag associated with the URL. Further, in one embodiment, the Header Score may be adjusted based on an originating country associated with an IP address included within the email message. In some embodiments, determining that the email is a phishing email may occur before the email message is sent to an email recipient.

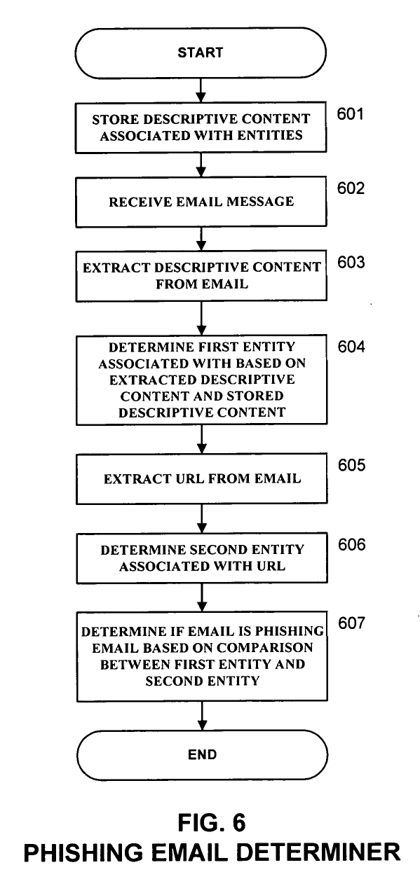

The Phishing Email Determiner of the present invention can also determine phishing emails based on descriptive content associated with an entity, such as a company, and which is extracted from an email message, as illustrated, for example, in the embodiment of FIG. 6. First, descriptive content including at least domain names and key words associated with one or more entities is stored 601. Second, an email message is received 602, and descriptive content is extracted from it 603. Fourth, a first entity is determined that the email may be associated with based on a comparison between the extracted descriptive content and the stored descriptive content 604. Fifth, a URL is extracted from the email 605, and a second entity is determined which is associated with the URL 606. Lastly, it is determined that the email is a phishing email based on a comparison between the first entity and the second entity 607.

The PED of FIG. 6 may be practically used, for example, to determine that an email is a phishing email when it purports to be from an user's bank, but is actually from an identify thief. Applying the PED embodied in FIG. 6, descriptive content is stored which is associated with a bank 601, called hypothetically FirstBank, which is associated with the domain name firstbank.com. Next, the method receives an email 602, and extracts descriptive content from the email 603. In the current example, the PED extracts the domain name 602 firstbank.com from the email message. Next, the PED compares the extracted domain to the descriptive content stored at step 601, and determines that the extracted domain name is associated with FirstBank 604. A URL is then extracted from the email 605, which is determined to not belong to FirstBank at 606. Finally, the PED of FIG. 6 compares the first entity, FirstBank, and the second entity, the URL not owned by FirstBank, and determines that the email is a phishing email based on the comparison 607.

In various embodiments of FIG. 6, the descriptive content can include any type of information, including domain names, keywords, graphic images, sound files, video files, attached files, digital fingerprints, and email addresses. In a further embodiment of the PED, the step of determining a second entity associated with the URL can comprise the step of determining an IP address associated with the URL, which may, for example, be determined by querying a DNS server.

In another embodiment based on that of FIG. 6, an interface is provided which allows a user to determine keywords and domain names to associate with an entity. The keywords and domain names are then stored and associated with the entity. The storage, for example, may occur in a database residing on the computer system illustrated in FIG. 3.

Trusted Host Miner

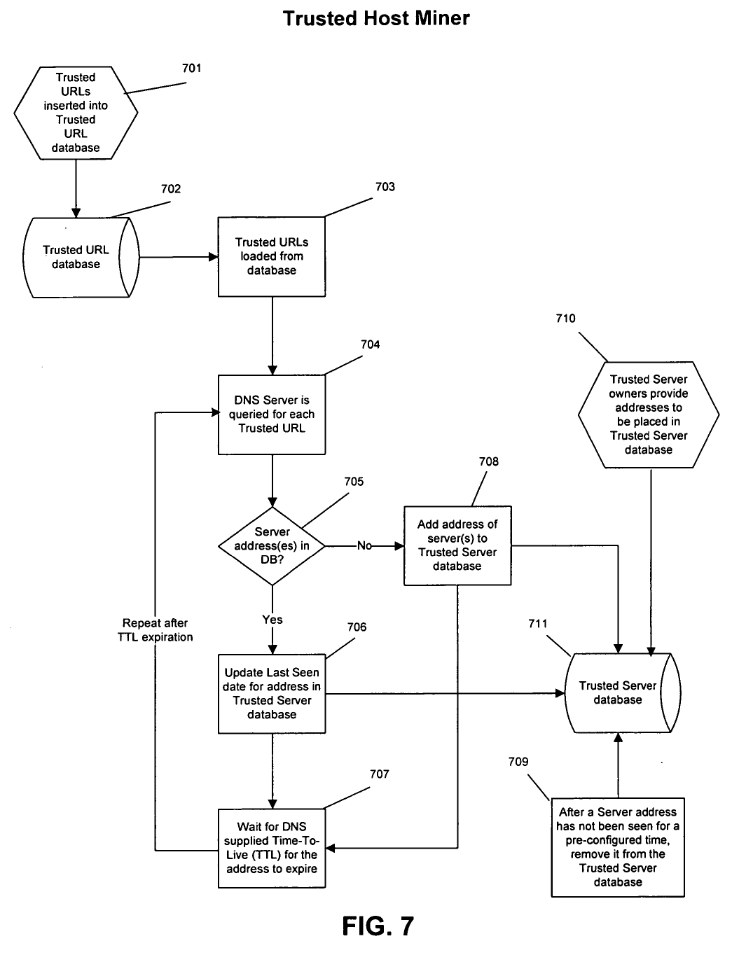

The Trusted Host Miner (THM) of the present invention is capable of discovering the IP addresses of all servers that serve a particular Trusted URL, and is illustrated in the embodiment of FIG. 7. The servers that serve a Trusted URL are known as Trusted Servers. In various embodiments, the THM is responsible for keeping a database of Trusted Servers up 702 to date by pruning servers that no longer are used for a particular Trusted URL.

In one embodiment, the THM loads the list of Trusted URLs that it is responsible for discovering and maintaining from the Trusted URL database 703. The THM then performs a DNS query for each URL 704. The DNS query also returns a time-to-live (TTL) value for each address it returns. Then, at step 705, it is determined if the server address is in the database. If the server address is in the database, then the Last Seen date for the address is updated in the Trusted Server Database 706. The THM then waits for the DNS supplied Time-To-Live (TTL) for the address to expire 707, and then repeats the DNS server query at step 704.

If it was determined at step 705 that the server address was not in the database, then the address of the server is added to the Trusted Server database 708. The THM can then wait for the TTL for the address to expire, and repeat the THM method starting at step 704.

If a particular Trusted Server has not been seen for a configured amount of time, the THM can prune the server by removing 709 it from the Trusted Server database 711. This action ensures that the Trusted Server database 711 is always current and doesn't contain expired entries.

The Trusted Server database can also be preloaded with sets of Trusted Servers that are provided by the owners of those servers 710. For example, a financial institution could provide a list of its servers that are trusted. These would be placed in the Trusted Server database 711 and not mined by the THM.

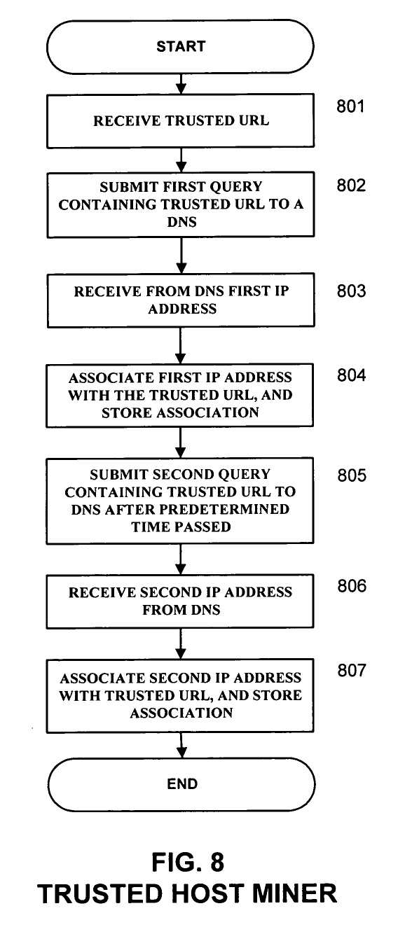

The THM of another embodiment is illustrated in FIG. 8. First, the THM receives the Trusted URL 801. Second, the method submits a first query containing the Trusted URL to a DNS 802, and then receives from the DNS a first IP address 803. Fourth, the first IP address is associated with the Trusted URL, and the association is stored 804. A second query is then submitted to the DNS containing the Trusted URL after a first predetermined time has passed, the first predetermined amount of time being a function of the TLL valued received from the DNS 805. Sixth, a second IP address is received from the DNS 806. Finally, the second IP address is associated with the Trusted URL, and the association is stored 807.

In an embodiment of the THM extending the embodiment of FIG. 8, the THM method disassociates an IP address from the Trusted URL after a second pre-configured amount of time has passed. Additionally, the second preconfigured amount of time may be determined as a function of a TTL value. In a further embodiment, the Trusted URL is received as the result of a database query, and the IP addresses, TTL values, and Trusted URLs may be stored in a database residing on the computer system of FIG. 3.

Trusted Host Browser

The present invention provides a Trusted Host Browser (THB) method for communicating a level of trust to a user. In one embodiment, the THB uses the Trusted Server database 711, and Trusted Host Browser is implemented as a web browser plug-in which can be useable via a toolbar. The plug-in may be loaded into a web browser and used to provide feedback to the end user regarding the security of the web site they are visiting. For example, if the end user clicks on a link in an email message they received in the belief that the link is to their bank's website, the plug-in can indicate visually whether they can trust the content delivered into the web browser from the website.

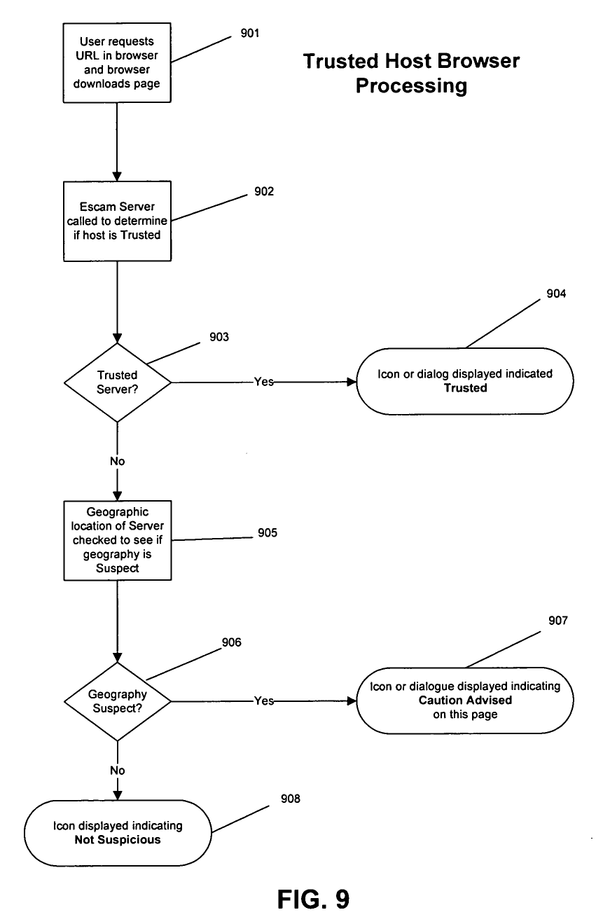

In one embodiment of the THB as illustrated in FIG. 9, the THB plug-in takes the URL loaded in the web browser request area and looks up the address associated with the URL 901. The plug-in then calls the EScam Server 202 with the address indicating to verify it against the addresses in the Trusted Server database 902. If the address is a Trusted Server 903, the plug-in will display an icon or dialogue box to the user indicating “Trusted Website” 904.

If the EScam Server 202 determines that the server is not trusted, it then checks the geographic location of the server 905. If the geographic location is potentially suspicious 906, such as an OFAC country or a pre-determined suspect country, the EScam Server 202 can indicate this to the plug-in. If the geographic location is not suspicious, the plug-in may then display an icon in the browser indicating “Non-Suspicious Website” 908. If the server location is suspicious, then the plug-in will display an icon indicating “Suspicious Website” 907. The end user can then use the information concerning the validity of the website to determine whether to proceed with interaction with this site, such as providing confidential information including the user's login, password, or financial information.

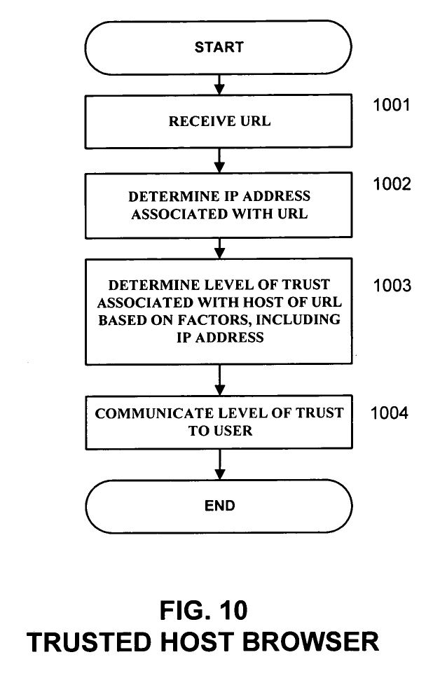

Another embodiment of the THB useful for communicating the level of trust to a user is illustrated in FIG. 10. In the embodiment of FIG. 10, the method first receives a URL 1001. Second, an IP address associated with the URL is determined 1002. Third, the level of trust associated with the host of the URL is determined based on one or more factors, with at least one factor based on the IP address 1003. Finally, the determined level of trust 1003 is communicated to the user 1004.

In an embodiment of the THB based on FIG. 10, the URL is entered into the address field of an Internet web browser. Further, a factor may be the level of trust received from an EScam Server 202 queried with the URL. Additionally, a factor may be the geographic location of the host determined as a function of the IP address. In one embodiment, the geographic location of the host may be determined by using a NetAcuity Server 240.

Page Spider

One embodiment of the present invention provides a Page Spider method which is useful for processing links in documents to determine on-site URLs which may require the communication of confidential or sensitive information such as user credentials, login, password, financial information, social security number, or any type of personal identification information. The URLs which refer to on-site web pages requesting confidential information may also be treated as Trusted URLs, added to the Trusted URL database 711, and processed by the THM.

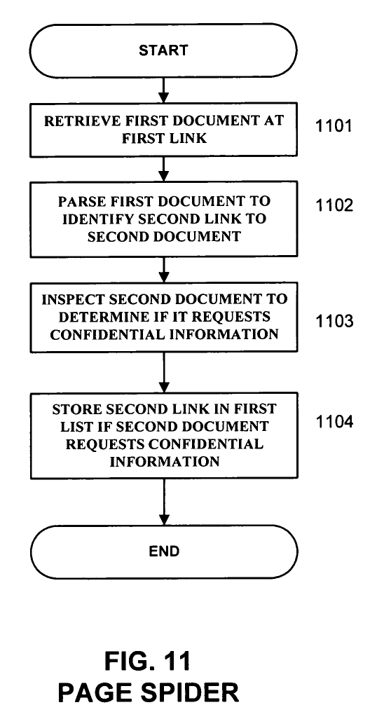

The Page Spider method is illustrated in one embodiment depicted in FIG. 11. The Page Spider of FIG. 11 can use logic to categorize URLs into either a Secure Page URL, or an All Inclusive URL, which is any URL not determined to require a login or doesn't request personal or sensitive information. First, a first document is retrieved which is available at a first link, the first link containing a first host name 1101. Second, the first document is parsed to identify a second link to a second document, with the second link containing the same host name as the first host name 1102, i.e. the second link is on-site with regard to the first link. The second document is then inspected to determine if it request confidential information such as login, password, or financial information 1103. Finally, if the second document does request confidential information, the second link is stored in a first list 1104. In a further embodiment, the second link may be stored in a second list if the second document does not request confidential information.

In another embodiment of the Page Spider, the documents are HTML compatible documents, and the links are URLs. In further embodiments of the Page Spider, the documents are XML documents and the links are URLs. It will also be apparent to one of skill in the art that the Page Spider can be used with any type of document which contains one or more links or references to other documents.

In yet another embodiment, the first document may be parsed to determine an HTML anchor tag <A> which contains a link to the second document. The second document may also be inspected to determine if it request confidential information by determining if it contains one or more predetermined HTML tags such as the <FORM> or <INPUT> tag. In various embodiments, the confidential information may be requested by a secure login form.

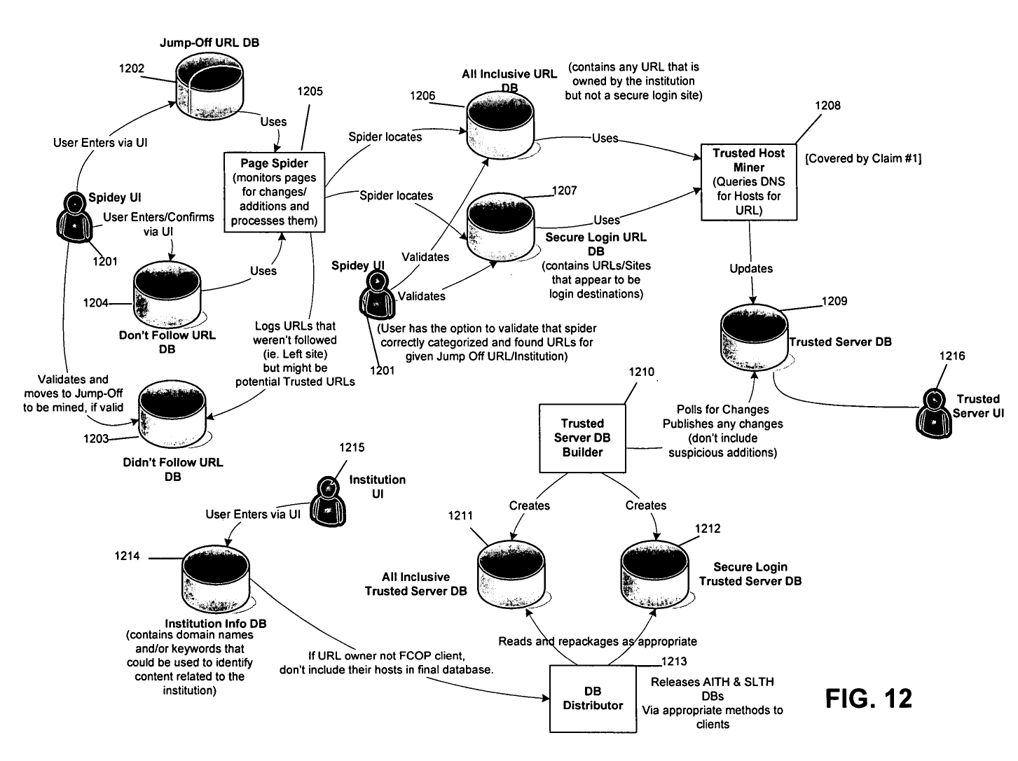

One or more embodiments of the present invention may be combined to provide enhanced functionality, such as the embodiment shown in FIG. 12, which illustrates the Page Spider and Trusted Host Miner operating together.

In the embodiment illustrated in FIG. 12, the Page Spider is responsible for scanning a page for all possible URLs or sites given a Jump-Off URL from a Jump-Off URL database 1202. The Page Spider uses logic to categorize URLs into either a Secure Login URL, or an All Inclusive URL, which is any URL not determined to require a login. URL processing by the Page Spider is useful for methods which need to know if a URL request confidential information, such as a secure login URL, or if it's just a regular URL. In various embodiments, the Page Spider does not follow links off of the current site, but adds off-site links to a Didn't Follow database 1203 for a human to verify if they should be converted into Jump-Off URLS. In one embodiment, Jump-Off URLs are potentially Trusted URLs which may be processed by the Trusted Host Miner 1208.

In the current embodiment, a Page Spider User Interface (UI) 1201 is provided, which allows a user to input Jump-Off URLs, input Don't Follow URLs, and validate Didn't Follow URLs and place them in the Jump-Off URL database 1202. The Page Spider UI 1201 may also be used to validate All Inclusive database 1206 entries, validate Secure Login URL database 1207 entries, and to manually enter All Inclusive/Secure URLs, bypassing Page Spider processing.

In the embodiment of FIG. 12, the Page Spider 1205 is used via the Page Spider UI 1201 to enter URLs into the Jump-Off URL DB 1202, the Don't Follow URL DB 1204, and the Didn't Follow URL DB 1203. The Page Spider locates on-site URLs and places them in either the All Inclusive URL DB 1206, or the Secure Login URL DB 1207. These located URLs are then supplied to the THM 1208, which determines Trusted Hosts for supplied URLs as illustrated, for example, in FIG. 7 and FIG. 8. The THM 1208 then updates the Trusted Server DB 1209.

In another embodiment, a Trusted Server DB Builder 1210 polls the Trusted Server DB 1209, and when there are sufficient changes made, publishes URLs to the All Inclusive Trusted Server DB 1211 and the Secure Login Trusted Server DB 1212. In a further embodiment, a DB Distributor 1213 also sends URLs to the All Inclusive Trusted Server DB 1211 and the Secure Login Trusted Server DB 1212. Finally, a user uses an Institution UI 1215 to administer the Institution Info DB 1214, which contains descriptive content such as domain names and keywords that can be used to identify content related to the institution. The descriptive content may also be supplied to a PED coupled with the embodiment of FIG. 12, enabling the descriptive content to be used to determine phishing emails which purport to be from the institution.

While the invention has been described in detail in connection with various embodiments, it should be understood that the invention is not limited to the above-disclosed embodiments. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

We Claim:

1. A method for determining a phishing email, comprising the steps of:
a. receiving an email message;
b. scoring the email message based on one or more factors, wherein at least one factor is based on the level of trust associated with a URL extracted from the email;
c. comparing the score with a predetermined phishing threshold; and
d. determining if the email is a phishing email based on the comparison.

2. The method of claim 1, wherein one or more of the factors are stored in a database.

3. The method of claim 1, wherein the level of trust associated with the URL is determined as a function of an IP address associated with the URL.

4. The method of claim 3, wherein the IP address associated with the URL is determined by querying a DNS server.

5. The method of claim 1, wherein the level of trust associated with the URL is retrieved from a database.

6. The method of claim 1, wherein a factor comprises a geographic location of origination of the email message.

7. The method of claim 6, wherein the geographic location is determined as a function of the origination IP address of the email message.

8. The method of claim 1, wherein the step of determining if the email is a phishing email occurs in real time.

9. The method of claim 1, further comprising parsing the email message into a header and a body.

10. The method of claim 1, wherein the email message is an HTML email message.

11. The method of claim 1, wherein the email message is a text email message.

12. The method of claim 1, further comprising the steps of:
a. determining one or more URLs contained within the email message;
b. determining if the one or more URLs are associated with trusted servers;
c. if each of the one or more URLs are associated with a trusted server, optimizing the score to reflect that the email is less likely to be a phishing email; and
d. if fewer than all of the one or more URLs are not associated with trusted servers, optimizing the risk score to reflect that the email is more likely to be a phishing email.

13. The method of claim 9, wherein the score is comprised of a header score and a URL score.

14. The method of claim 13, wherein the URL score is adjusted based on a HTML tag associated with the URL.

15. The method of claim 13, wherein the header score is adjusted based on an originating country associated with an IP address included within the email message.

16. The method of claim 1, wherein the email message is received by an email client.

17. The method of claim 1, wherein the determining step occurs before the email message is sent to an email recipient.

18. The method of claim 1, further comprising reporting information associated with the determining step.

19. A method for determining a phishing email, comprising the steps of:
a. storing descriptive content associated with one or more entities, the content including at least domain names and keywords;
b. receiving an email;
c. extracting descriptive content from the email;
d. determining a first entity that the email may be associated with based on a comparison between the extracted descriptive content and stored descriptive content;
e. extracting a URL from the email;
f. determining a second entity associated with the URL; and
g. determining if the email is a phishing email based on a comparison between the first entity and the second entity.

20. The method of claim 19, wherein the step of determining a second entity associated with the URL comprises the step of determining an IP address associated with the URL.

21. The method of claim 20, wherein the IP address is determined by querying a DNS server.

22. The method of claim 19, wherein the step of storing descriptive content associated with one or more entities comprises the steps of:
a. providing an interface for a user to determine keywords and domain names associated with an entity;
b. determining by the user keywords associated with the entity;
c. determining by the user domain names associated with the entity; and
d. storing entity information, the associated keywords, and the associated domain names.

23. The method of claim 22, wherein the entity, keyword, and domain name information is stored in a database.

24. A method for associating one or more Internet Protocol (IP) addresses of a trusted server with a trusted Uniform Resource Locator (URL), comprising the steps of:
a. receiving the trusted URL;
b. submitting a first query containing the trusted URL to a Domain Name Server (DNS);
c. receiving from the DNS a first IP address;
d. associating the first IP address with the trusted URL, and storing the association;
e. submitting a second query containing the trusted URL to the DNS after a first predetermined amount of time has passed, wherein the first predetermined amount of time is a function of a time-to-live (TTL) value received from the DNS;
f. receiving from the DNS a second IP address; and
g. associating the second IP address with the trusted URL, and storing the association.

25. The method of claim 24, wherein the step of receiving the trusted URL comprises the step of receiving the trusted URL as the result of a database query.

26. The method of claim 24, further comprising the step of storing one or more IP addresses, TTL values, and the trusted URL in a database.

27. The method of claim 24, further comprising the step of disassociating an IP address from the trusted URL after a second preconfigured amount of time has passed.

28. The method of claim 27, wherein the second preconfigured amount of time is determined as a function of a TTL value.

29. The method of claim 24, further comprising the step of receiving an IP address associated with the trusted URL from an entity associated with the trusted server.

30. The method of claim 29, wherein the entity is the owner of a trusted server.

31. The method of claim 24, wherein steps e through h are repeated one or more times.

32. A method for communicating to a user the level of trust associated with a host of a Uniform Resource Locator (URL), comprising the steps of:
a. receiving the URL;
b. determining an Internet Protocol (IP) address associated with the URL;
c. determining the level of trust associated with the host of the URL based on one or more factors, wherein at least one factor is based on the IP address; and
d. communicating to the user the level of trust associated with the host.

33. The method of claim 32, wherein the URL is a URL entered into the address field of an internet web browser.

34. The method of claim 32, wherein a factor is the level of trust received from an EScam server queried with the URL.

35. The method of claim 32, wherein the step of determining an IP address associated with the URL comprises the step of querying a DNS with the URL.

36. The method of claim 32, wherein a factor is the geographic location of the host determined as a function of the IP address.

37. The method of claim 32, wherein the step of determining an IP address associated with the URL comprises the step of retrieving the IP address from a database.

38. The method of claim 32, wherein the step of communicating to the user comprises the step of communicating to the user the level of trust associated with the host by displaying a message to the user indicating the level of trust associated with the URL.

39. The method of claim 32, wherein the step of communicating to the user comprises the step of communicating to the user the level of trust associated with the host by displaying an icon or dialogue box to the user indicating the level of trust associated with the URL.

40. A method for processing links in documents, comprising the steps of:
a. retrieving a first document available at a first link, the first link containing a first host name;
b. parsing the first document to identify a second link to a second document, wherein the second link contains the same host name as the first host name;
c. inspecting the second document to determine if it requests confidential information such as a login, password, or financial information; and
d. storing the second link in a first list if the second document requests confidential information.

41. The method of claim 40, further comprising the step of storing the second link in a second list if the second document does not requests confidential information.

42. The method of claim 40, wherein documents are HTML compatible documents and links are Uniform Resource Locators (URLs).

43. The method of claim 40, wherein documents are XML compatible documents and links are Uniform Resource Locators (URLs).

44. The method of claim 42, wherein the step of parsing the first document to determine a second link to a second document comprises the step of determining an <A> HTML tag which contains a link to the second document.

45. The method of claim 42, wherein the step of inspecting the second document to determine if it requests confidential information comprises the step of inspecting the second document to determine if it contains one or more predetermined HTML tags such as a <FORM> tag or a <INPUT> tag.

46. The method of claim 45, wherein the confidential information is requested by a secure login form contained within the second document.

47. The method of claim 40, wherein the confidential information is requested by a secure login form contained within the second document.

48. A method for processing links in documents, comprising the steps of:
a. retrieving a first document available at a first link, the first link containing a first host name;
b. parsing the first document to identify one or more links to other documents, wherein each identified link contains an identified host name, and wherein the one or more identified links include at least a second link containing a second host name;
c. determining, for the one or more identified links, if the first host name and the identified host name are the same;
d. if the first host name and the identified host name are the same, storing the identified link in a first list; and
e. if the first host name and the identified host name are not the same, storing the identified link in a second list.

49. The method of claim 49, further comprising the step of inspecting one or more links in the first list to determine if the inspected link references a document which requests confidential information such as a login, password, or financial information.

50. The method of claim 49, further comprising the steps of:
a. if the document referenced by the inspected link requests confidential information, storing the inspected link in a third list; and
b. if the document referenced by the inspected does not requests confidential information, storing the inspected link in a fourth list.

51. The method of claim 48, wherein documents are HTML compatible documents and links are Uniform Resource Locators (URLs).

52. The method of claim 48, wherein documents are XML compatible documents and links are Uniform Resource Locators (URLs).

53. The method of claim 51, wherein the step of parsing the first document to determine the second link to a second document comprises the step of determining an <A> HTML tag which contains a link to the second document.

54. The method of claim 51, wherein the step of inspecting the second document to determine if it requests confidential information comprises the step of inspecting the second document to determine if it contains one or more predetermined HTML tags such as a <FORM> tag or a <INPUT> tag.

55. The method of claim 54, wherein the confidential information is requested by a secure login form contained within the second document.

56. The method of claim 48, wherein the confidential information is requested by a secure login form contained within the second document.
